(19) United States
(12) Patent Application Publication
(10) Pub. No.: US 2026/0077957 A1
(43) Pub. Date: Mar. 19, 2026

(54) Conveyor Arrangement

(71) Applicant: Interroll Holding AG, Sant' Antonino (CH)

(72) Inventors: Christopher Matheisen, Hückelhoven (DE); Christian Ripperda, Hückelhoven (DE); Aryanti Putri, Hückelhoven (DE); Henrik Staf Hansen, Hückelhoven (DE)

(21) Appl. No.: 19/110,446

(22) PCT Filed: Sep. 4, 2023
(86) PCT No.: PCT/EP2023/074125

§ 371 Date: Mar. 11, 2025

(30) Foreign Application Priority Data
Sep. 14, 2022 (EP) 22195575.0

(51) Int. Cl. B65G 41/00; B65G 43/10; B65G 47/64

(52) U.S. Cl. CPC B65G 41/008; B65G 43/10; B65G 47/642; B65G 2203/0233; B65G 2203/0283

(57) ABSTRACT

Conveyor arrangement (100), comprising—a mobile conveyor (1) having a mobile conveyor track (21), —a stationary conveyor (8) having a stationary conveyor track (81): wherein in a regular mode of operation the mobile conveyor is operated in a mobile use and stationary use, and wherein in a regular mode of operation the stationary conveyor is operated in a stationary use and not in a mobile use, the mobile conveyor (1) has a travel module (3) and a conveyor module (2) separate thereof, wherein the travel module (3) is adapted to change its position within an area of operation, the mobile conveyor (1) has a conveyor module (2) comprising said mobile conveyor track (21): the conveyor arrangement (100) has—an arrangement control (104) adapted to coordinate overall conveying operations within the conveyor arrangement (100); —a travel module control (34) adapted to control the operation of the travel module (3), based on a message (S1, S3) provided by the central arrangement control (104); —a mobile conveyor control (24) separate to the travel module control (34) and adapted to control the operation of the mobile conveyor track (21) based on a message (S4) provided by the travel module control (34).

### CROSS REFERENCE TO RELATED APPLICATIONS

This application is the U.S. national stage of International Application No. PCT/EP2023/074125, filed on 2023 Sep. 4. The international application claims the priority of EP 22195575.0 filed on 2022 Sep. 14; all applications are incorporated by reference herein in their entirety.

### BACKGROUND

The invention refers to a conveyor arrangement.

European patent application EP22157909.7 (not published yet) discloses a conveyor arrangement, comprising a mobile conveyor and a plurality of stationary conveyors. The mobile conveyor has a conveying track adapted to convey an object between different positions along the conveying track, and a travel module adapted to change its position within an area of operation, in particular in a non-mechanically track-bound manner. The conveying track is fixed to the travel module, so that changing the position of the travel module leads to a similar change of the position of the conveying track.

U.S. Pat. No. 10,894,664 B1 discloses an arrangement having a plurality of mobile conveyors, each of which are connected to a central server. A data connection can be established between the mobile conveyors to coordinate transfer of an object between said conveyors. A similar arrangement is disclosed in U.S. Pat. No. 9,637,318 B2.

WO 2021/151529 A1 discloses an arrangement having a stationary conveyor and a mobile conveyor. A guard module is arranged in the interface between the mobile and stationary conveyor to prevent that object fall of the conveyor.

The two modules, conveying module and travel module, arise from different fields of technology. The travel module arises from the field of autonomous and driverless vehicles, whereas the conveying module arises from the technology of logistics and conveyor technology. Consequently the travel module and the conveying module are usually provided by different manufacturers. Up to now a conveying track is individually designed for the intended use with a certain travel module.

### SUMMARY

Conveyor arrangement (100), comprising
a mobile conveyor (1) having a mobile conveyor track (21), the mobile conveyor track (21) is adapted to convey an object (9) between different positions along said mobile conveyor track (21) and/or to transfer said object from and/or to said mobile conveyor (1),
a stationary conveyor (8) having a stationary conveyor track (81), the stationary conveyor track (81) is adapted to convey an object (9) between different positions along said stationary conveyor track (81) and/or to transfer said object from and/or to said stationary conveyor (8);
   wherein in a regular mode of operation the mobile conveyor is operated in a mobile use and stationary use, and
   wherein in a regular mode of operation the stationary conveyor is operated in a stationary use and not in a mobile use,
   the mobile conveyor (1) has a travel module (3) and a conveyor module (2) separate thereof,
   wherein the travel module (3) is adapted to change its position within an area of operation, in particular in a non-mechanically track-bound manner,
   the mobile conveyor (1) has a conveyor module (2) comprising said mobile conveyor track (21);
   the conveyor arrangement (100) has
an arrangement control (104) adapted to coordinate overall conveying operations within the conveyor arrangement (100);
a travel module control (34) adapted to control the operation of the travel module (3), in particular to control the operation of a travel drive (M3) of the travel module (3), based on a message (S1, S3) provided by the central arrangement control (104);
a mobile conveyor control (24) separate to the travel module control (34) and adapted to control the operation of the mobile conveyor track (21) based on a message (S4) provided by the travel module control (34).

### DETAILED DESCRIPTION

It is the object of the present invention to simplify the process of providing the mobile conveyors to the users which are best adapted for the intended usage. The invention comprises a conveyor arrangement and a method according to the main claims; embodiments are subject of the subclaims and the description.

The conveyor arrangement comprising: a mobile conveyor having a mobile conveying track, the mobile conveying track is adapted to convey an object between different positions along said mobile conveying track and/or to transfer said object from and/or to said mobile conveyor; a stationary conveyor having a stationary conveyor track, the mobile conveying track is adapted to convey an object between different positions along said stationary conveyor track and/or to transfer said object from and/or to said stationary conveyor. The mobile conveyor has a travel module and a conveying module separate thereof, wherein the travel module is adapted to change its position within an area of operation, in particular in a non-mechanically track-bound manner, the mobile conveyor has a conveying module comprising said mobile conveying track. The conveyor arrangement has an arrangement control adapted to coordinate overall conveying operations within the conveyor arrangement; a travel module control adapted to control the operation of the travel module, in particular to control the operation of a travel drive of the travel module, based on a message provided by the central arrangement control; a mobile conveyor control separate to the travel module control and adapted to control the operation of the mobile conveyor track based on a message provided by the travel module control.

The arrangement control provides instructions to the other controls, where the other controls are adapted to control the hardware operating the conveying process.

In an embodiment the travel module has a travel module housing and the conveying module has a fixing frame. The fixing frame is separate to the travel module housing, wherein the fixing frame is attached to the travel module housing by a fastener, wherein the travel module control is attached to the travel module housing, wherein the mobile conveyor module control is attached to the fixing frame.

As a consequence the travel module is a separate unit having all components relevant for performing the driving operation. This is due to the fact that any travel module can be used which is available on the market and which basically is not equipped with conveying functionality. On the other hand the mobile conveying module comprises all components which is relevant for the accommodation of an object on the mobile conveyor and conveying the object on top of the mobile conveyor, consequently also a mobile conveyor control.

This clear separation in the functions make it easy to use the individual components with other components of other manufacturers. Clear interfaces enable easy communication and exchangeability between the modules. Therefore the travel module as well as the mobile conveying module each have their own separate control.

In an embodiment the arrangement control is connected to the travel module control by a first data connection; that the travel module control is connected to the mobile conveyor control by a second data connection. The first data connection is in particular a wireless data connection and/or a permanent data connection; the second data connection is in particular a wired data connection and/or a permanent data connection.

In an embodiment a stationary control is adapted to control the operation of the stationary conveyor track based on a message provided by the mobile conveyor module control.

In an embodiment the stationary control is connected to the mobile conveyor control by a third data connection.

In an embodiment the third data connection is a temporary data connection. In particular the third data connection uses a near-field data communication technology, in particular wherein the near-field data communication technology is requiring a defined orientation between the mobile conveyor and the stationary conveyor.

The term “orientation” is to be understood different to a distance. Because in the near-field communication, besides distance, an angular orientation and/or lateral orientation (in particular lateral shift) plays a significant role. Consequently even if the near-field communication means are located very close to each other, communication may nevertheless be impossible since the means may not be oriented properly relative to each other. In particular an NFC technology or directed light beams (e.g. infrared light) are used as communication means.

In an embodiment the mobile conveyor control receives a message to start operation from the travel module control.

In an embodiment the stationary conveyor control receives a message indicating to start operation from the mobile conveyor control.

In an embodiment the arrangement control receives a message confirming that an object has been delivered from the mobile conveyor to the stationary conveyor from the travel module control.

In an embodiment the travel module control receives a message confirming that the object has been transferred from the mobile conveyor to the stationary conveyor from the mobile conveyor control.

In particular information between the various controls can be provided in different manner. In an embodiment the information is provided in a push-like manner, thereby a first control actively provides said information independent from the question, whether said any second control is interested in said information. In another embodiment the information is provided in a pull-like manner, thereby a first control provides said information only in response to a request for sending said information. In still another embodiment the information is stored within a memory of the first control, where a second control can access the database for retrieving said information.

The regular mode of operations includes a stationary and a mobile use of the mobile conveyor.

The regular mode of operation includes merely the stationary operation of the stationary conveyor.

In the stationary use, the conveyor does not change its position within the area of operation when conveying objects. In the mobile use the conveyor change its position within the area of operation when conveying objects.

Accordingly, in particular a main difference between the mobile conveyor and the stationary conveyor is that during regular mode of operation the stationary conveyor stays at its position and in particular therefore it is void of a travel drive. The stationary support frame cannot be moved within the arrangement area during regular mode of operation.

In the regular mode of operation the conveyors participate in conveying objects.

During a maintenance mode of operation the position of a stationary conveyor may be amended from time to time outside of the regular modes of operation. In the maintenance mode of operation a stationary conveyor does not participate in conveying objects. For this purpose it is optional that individual stationary conveyors can be taken out of the regular operation mode, where other conveyors at the same time may continue to operate in regular mode of operation.

### BRIEF DESCRIPTION OF THE DRAWINGS

An example embodiment of the invention is described with respect to the figures; herein show

FIG. 1 a conveying arrangement in top view having a mobile conveyor and a plurality of stationary conveyors;

FIG. 2 details of a non-claimed conventional conveyor arrangement
a) where a mobile conveyor is in a separated state to a stationary conveyor,
b) where the mobile conveyor is in a handover state with the stationary conveyor;

FIG. 3 a mobile conveyor of a claimed conveying arrangement in detailed view;

FIG. 4 a stationary conveyor of a claimed conveying arrangement in detailed view;

FIG. 5 details of a claimed conveyor arrangement using the mobile and stationary conveyors according to FIGS. 3 and 4
a) where the mobile conveyor is in a separated state to the stationary conveyor,
b) where the mobile conveyor is in a handover state with the stationary conveyor;

FIG. 6 a diagram illustrating the communication between the controls within the arrangement of FIG. 5.

### DETAILED DESCRIPTION OF THE PREFERRED EMBODIMENTS

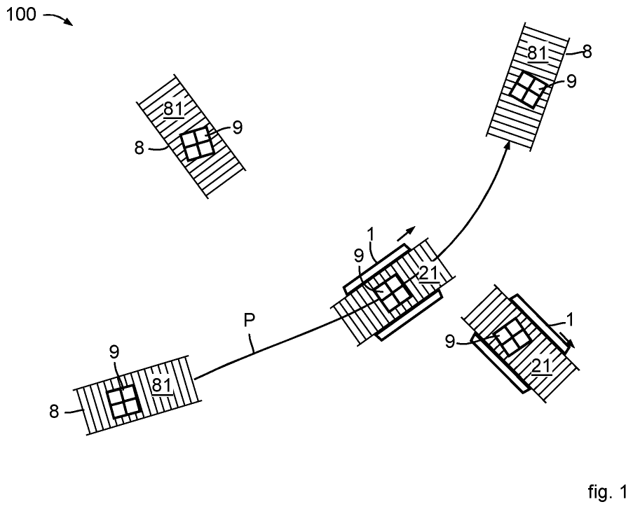

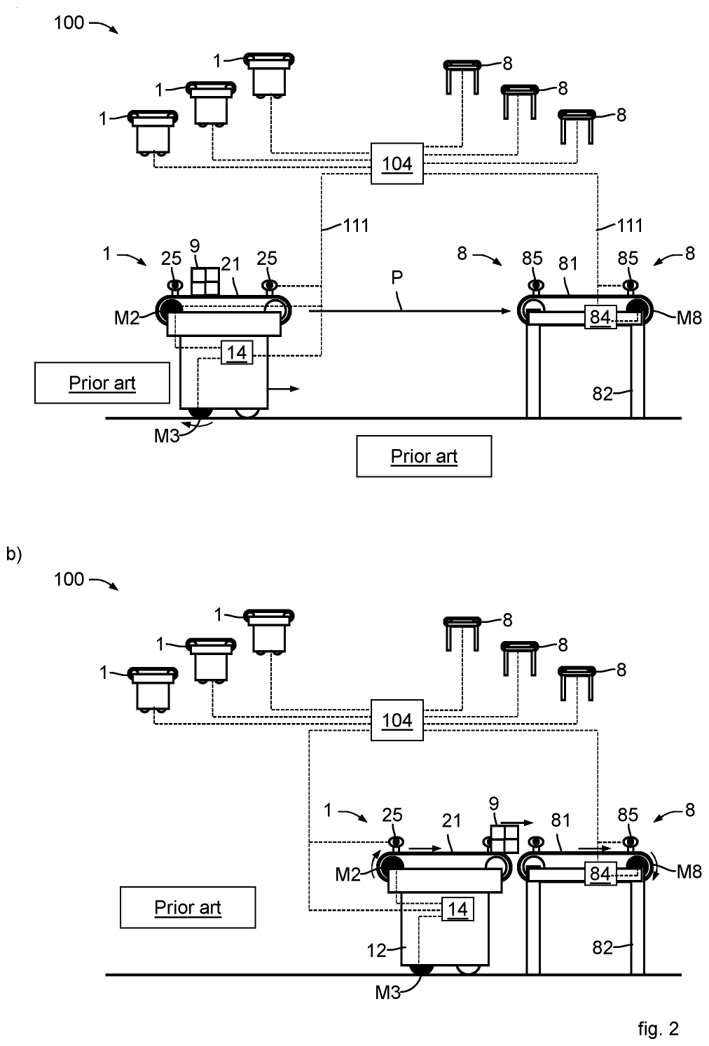

FIG. 1 shows a in general conveying arrangement 100 in top view to which the invention can be applied. Details of a non-claimed arrangement are shown in FIG. 2. FIGS. 1 and 2 are described in common. The below parts of the description is also applicable to the inventive conveying arrangement.

The conveying arrangement 100 has a number of stationary conveyors 8.

Stationary means that during intended use the location of the stationary conveyors 8 is fixed. But it is possible that during a modification of the conveying arrangement 100 the location of the stationary conveyors 8 may be changed from time to time, where such modification usually happens outside of the intended usage.

The stationary conveyor 8 has a stationary conveyor track 81 and a stationary support frame 82, on which the conveyor track 81 is mounted. A stationary conveyor drive M8 provides drive power to the stationary conveyor track 81. One or more stationary presence sensors 85 may be provided along the stationary conveyor track 81 to detect the presence of an object 9 to be conveyed on the stationary conveyor track 81. A stationary conveyor control 84 controls operation of the stationary conveyor drive M8 in particular under consideration of a presence signal provided by the presence sensor 85.

The conveying arrangement 100 has a at least one, in particular a plurality of, mobile conveyors 1. The mobile conveyor 1 is adapted to drive within the conveying arrangement 100, which is herein called the driving operation.

With the conveying arrangement 100 an object 9 can be transported between any of the stationary conveyors 8 by means of the mobile conveyor 1 along a conveying path P. The conveying path P doesn't need to be a predefined conveying path; here the mobile conveyor 1 may drive autonomously along any in particular a shortest conveying path P, where the conveying path P may be defined individually for each individual driving operation.

The mobile conveyor 1 comprises a mobile conveyor track 21 and a mobile conveyor drive 2M for providing drive power to the mobile conveyor track 21. As an optional feature the mobile conveyor 1 has at least one mobile presence sensor 25 for detecting the presence of an object within the mobile conveyor track 21.

The mobile conveyor 1 can change its position within the conveyor arrangement 100. The mobile conveyor is in particular an autonomous guided vehicle (AMR), which is adapted to autonomously control its movement. The mobile conveyor 1 comprises a travel drive M3, which is adapted to provide the mobile conveyor 1 with mechanical power to enable change of its position.

The travel drive M3 has in particular at least one motor driven wheel and a steering mechanism, where any solution provided in the prior art can be used. The mobile conveyor may comprise an energy storage (not shown), in particular a battery for rechargeable loading with electric power, which provides electric power to the travel drive M3 and the mobile conveyor drive M2.

In an embodiment the conveyor track (mobile and/or stationary) 21, 81 is a belt conveyor track. The belt conveyor track comprises a belt which is arranged around rollers. In an alternative embodiment the conveyor track is a roller conveyor track having a plurality of rollers arranged one behind the other and forming a conveying surface. Any kind of conveyor track can be used (see explanations in European patent application EP22157909.7, description related to FIGS. 2a, 2b).

FIG. 2a shows the mobile conveyor 1 in a separated state. In the separated state the mobile conveyor 1 is located at a distance to a stationary conveyor 8.

Transferring of objects cannot be performed by operation of the conveyor tracks 21, 81. Now the conveyor track can be used merely for amending the position of the object 9 within the conveyor track. A transfer of the object can be performed by other means, e.g. manually by a person lifting the object.

FIG. 2b shows the mobile conveyor 1 in a handover state with a stationary conveyor 8. Now the mobile conveyor 1 is located close to said stationary conveyor 8, so that transferring of an object 9 can be performed by operation of the mobile and stationary conveyor tracks 21, 81.

The above description refer to both of the conventional and the inventive conveying arrangement.

In the conventional arrangement the conveying arrangement 100 has several controls for controlling it's components.

An arrangement control 104 is controlling overall operation of the conveyor arrangement 100.

A mobile control 14 is located at the mobile conveyor 1, controlling operation of the mobile conveyor 1, in particular of the mobile drive M3 and the mobile conveyor track 21.

A stationary control 84 is located at the stationary conveyor 8, controlling operation of the stationary conveyor 8, in particular the stationary conveyor drive M8 and stationary conveyor track 81.

The mobile control 14 and the stationary control 84 are connected to the arrangement control 104 via a data connection 111. The arrangement control 104 provides destination instructions to the mobile control 14. Based on the provided destination instruction the mobile conveyor 1 travels autonomously to a specific destination. Such a destination is in particular a location, where the mobile conveyor 1 can get in a handover state with a stationary conveyor 8 as shown in FIG. 2b.

As soon as the mobile conveyor 1 has reached the intended destination, the arrangement control 104 provides conveying instructions to the mobile control 14, instructing to start conveying operation of the mobile conveying track 21.

At the same time the arrangement control 104 provides conveying instructions to the stationary control 84, instructing to start conveying operation of the stationary conveyor track 81. Thereby presence signals provided by the mobile and stationary presence sensors 25, 85 are considered.

By the mobile presence sensor 25 the arrangement control 104 detects a movement of the object 9 on the mobile conveyor track 21 passing the mobile presence sensor 25. By the stationary presence sensor 85 the arrangement control 104 detects a movement of the object 9 on the stationary conveyor track 81 passing the stationary presence sensor 25. This information is used by the arrangement control 104 to provide instructions to the mobile and stationary controls 14, 84 to initiate stop and/or start operation of the mobile and the stationary conveyor track 21, 81.

Thereby the mobile control 14 and the stationary control 84 (both also referred as the local controls) serve as I/O devices; that means that local controls 14, 84 provide access for the arrangement control 104 to the field devices M3, M8, 25, 85, so that the arrangement control 104 can provide the operation instructions to a conveyor track e.g. “M3 start drive”, “M3 stop drive”, and that the arrangement control 104 has access to the signals provided by the presence sensors 25, 85, e.g. “sensor 85 object detected” or “sensor 85 no object detected”. The arrangement control 104 provides via the local controls 14, 84 direct instruction to the conveying drives M2, M8, what is depicted in FIG. 2 as a direct dotted line between the conveying drives M2, M8 and the arrangement control 104.

No direct data connection is provided between the mobile control and the stationary control 14, 84. In case that the mobile control communicates with the stationary control, this communication happens via the arrangement control 104.

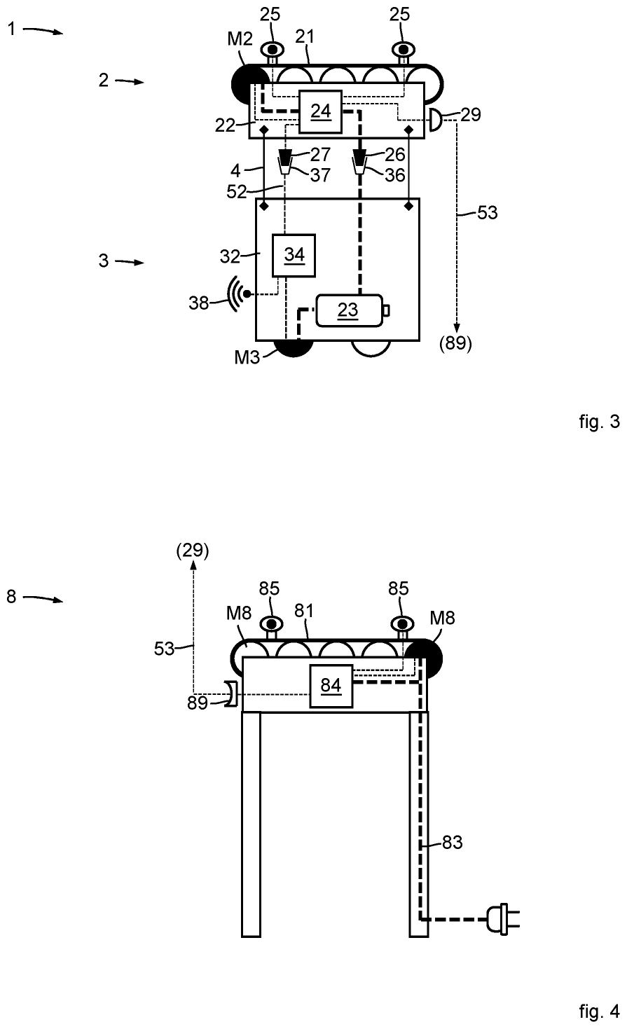

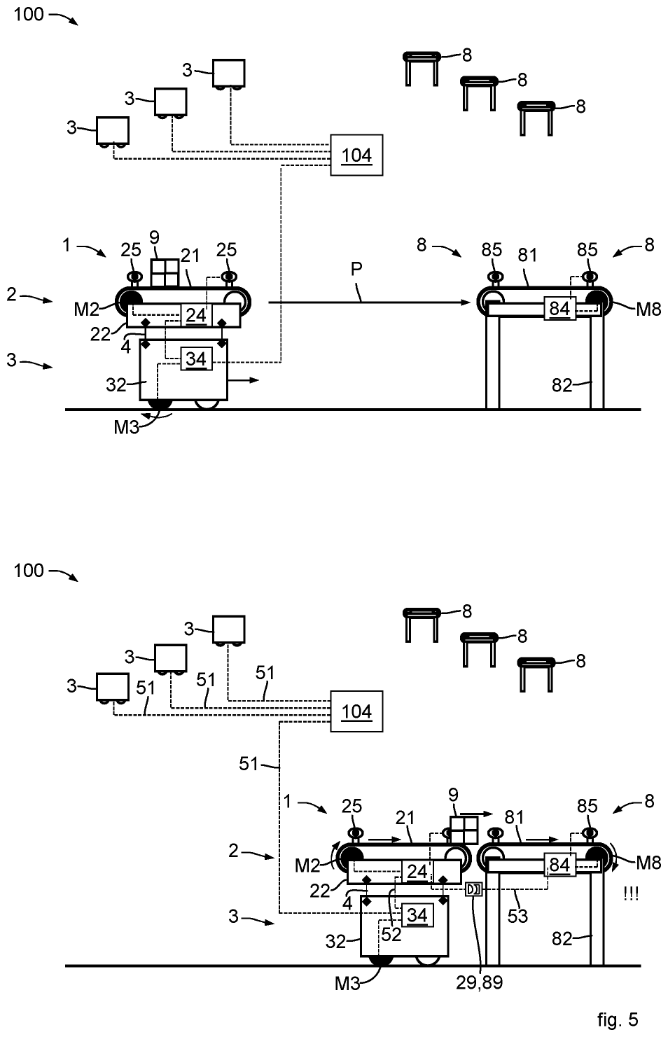

FIG. 5 shows a conveying arrangement 100 according to the present invention, FIGS. 3/4 show a mobile conveyor 1/a stationary conveyor 8 of said inventive conveying arrangement 100 in more detail.

FIG. 3 shows a mobile conveyor 1 of the inventive arrangement 100 in more detail. The mobile conveyor 1 comprises a travel module 3 and a conveyor module 2.

The travel module 3 is adapted to enable, that the mobile conveyor 1 can change its position within the conveyor arrangement. The travel module 3 is in particular an autonomous guided vehicle (AMR), which is adapted to control its movement autonomously. The travel module 3 comprises the travel drive M3, which is adapted to provide the travel module 3 with mechanical power to enable change of its position. The travel module 3 comprises a travel module control 34, at least controlling operation of the travel drive M3. The travel module 3 has a wireless control interface 38. The travel module control 34 is connected to the arrangement control 104 via the wireless control interface 38. In the following this data connection is called the first data connection 51.

The components of the travel module 3 are attached at or in a travel module housing 32.

The conveyor module 2 comprises said conveyor track 21 and a mobile conveyor control 24, controlling operation of said conveyor track 21. Also the at least one optional mobile presence sensor 25 is comprised within the conveyor module 2.

The conveyor module 2 also comprises a mobile conveyor drive M2, which is in particular an electric motor. The mobile conveyor drive M2 provides mechanical drive power enabling the conveyor track to move the object 9 relative to/within the mobile conveyor 1.

All components of the conveyor module are attached to a mobile support frame 22 of the conveyor module 2.

In an assembled state the mobile support frame 22 is attached to the travel module housing 32 by a fastener 4. The fastener 4 may comprise conventional fixing means like screws, bolts, etc. The fastener 4 may comprise an adapter which is adapted to specific fixing interfaces of the conveyor module 2 and/or the travel module 3.

The conveyor module 2 has a conveyor module energy interface 26 and a conveyor module control interface 27.

The travel module 3 has a travel module energy interface 36 and a travel module control interface 37.

In an assembled state of the mobile conveyor 1, the conveyor module energy interface 26 is connected to the travel module energy interface 36 and the conveyor module control interface 27 is connected to the travel module control interface 37. By connecting the data interfaces a second data connection 52 is established between the travel module control 34 and the mobile conveyor control 24. Energy can be provided by the energy storage 33 of the travel module 3 to the components of the conveyor module 2, in particular to the mobile conveyor control 24, the mobile conveyor drive M2 and/or the presence sensor 25.

During regular operation of the conveying arrangement 100 the second data connection 52 is permanent. That means, that the second data connection 52 will not be disconnected during regular operation.

In a disassembled state, e.g. for maintenance work outside the regular operation, the fastener 4 may be released, the conveyor module energy interface 26 may be disconnected from the travel module energy interface 36 and the conveyor module control interface 27 may be disconnected from the travel module control interface 37. Now the complete conveyor module 2 can be removed from the travel module 3. Consequently, the second data connection 52 is disconnected.

The stationary conveyor 8 has in particular an autonomous energy support. In particular the energy support comprises a power line 83 having a plug, which can be plugged into a socket (not shown). Alternatively the energy support can be provided by the mobile conveyor 1 as described in EP22157909.7.

In contrast to the conventional arrangement, in the inventive arrangement the stationary conveyor 8 is not connected to the arrangement control 104. The stationary conveyor 8 is in particular a standalone device which communicates directly with a mobile conveyor 1 in particular when the mobile conveyor 1 is in a handover state with the stationary conveyor 8.

Therefore the stationary conveyor 8 has a stationary control coupler 89 and the conveyor module 2 has a mobile control coupler 29. The mobile control coupler 29 and the stationary control coupler 89 are adapted to establish a temporary data connection between the conveyor module 2 and the stationary conveyor 8, which is in the following called the third data connection 53.

Temporary means in this context, that after initial installation and during regular operation of the conveying arrangement 100, the third data connection 53 is regularly connected and disconnected again in particular depending on the spatial relation between the stationary conveyor 8 and the mobile conveyor 1.

It is preferred that both couplers 29, 89 are using a near-field communication technology for establishing said third data connection 53. A near-field communication technology requires at least that a defined maximum distance and/or a spatial relation between the two couplers is maintained.

In particular the couplers 29, 89 are arranged at the respective frames 22, 82 in a manner that the third data connection 53 can only be established, in case that the mobile conveyor 1 and the stationary conveyor 8 are located in a handover state.

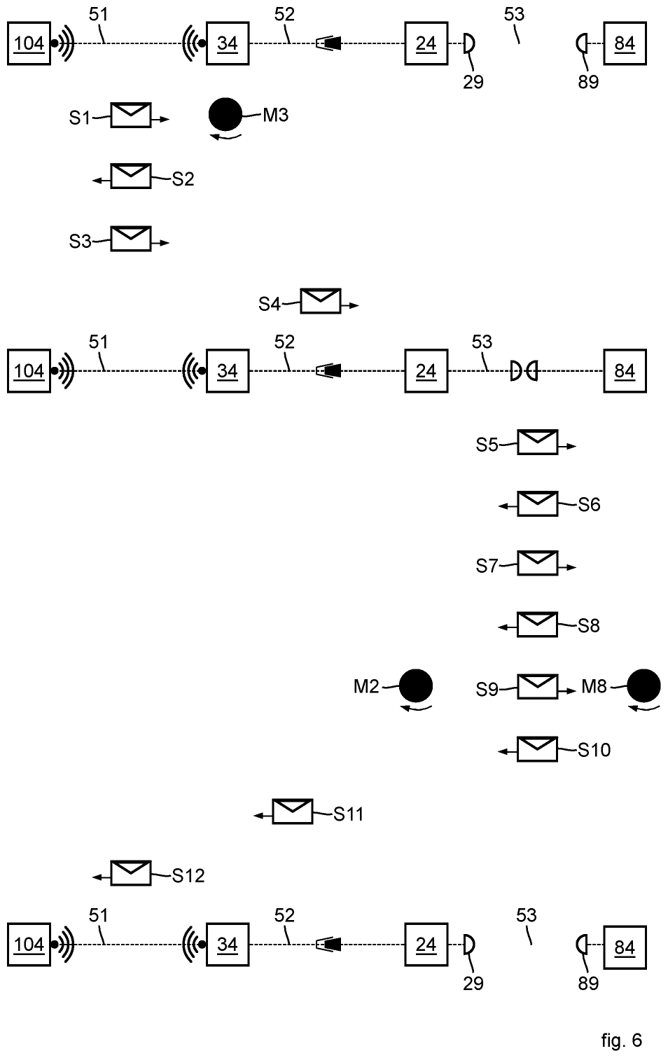

Controlling the operation of the arrangement is conducted as following with respect to FIG. 6.

The mobile control 14 and the stationary control 84 are not connected to the arrangement control 104. Instead merely the travel module control 34 is connected to the arrangement control 104 via the first data connection 51.

The arrangement control 104 provides destination instructions to the travel module control 34 in a first message S1. Based on the provided destination instruction the mobile conveyor 1 travels to a target destination autonomously. Such a target destination is in particular a location, where the mobile conveyor 1 is in a handover state with a stationary conveyor 8 as shown in FIG. 2b.

As soon as s the mobile conveyor 1 has reached the target destination, the travel module control 34 provides confirmation to the arrangement control 104 in a second message S2, that the travel module 3 has reached the target destination.

In a third message S3 the arrangement control 104 sends a request to the travel module control 34 to start delivering a loaded object 9 to a stationary conveyor 8. The travel module control 34 is not in a position to finally initiate the conveying process, since it has no direct access to the conveying hardware of the conveyor module 2. Consequently in a fourth message S4 the travel module control 34 sends a request to the mobile conveyor control 24 to start delivering a loaded object 9 to the destination, here the stationary conveyor 8.

As soon as the mobile conveyor 1 has reached the target position, the mobile conveyor 1 is in a handover position with a stationary conveyor 8.

Now a position check is performed. Therefore the mobile conveyor control 24 tries to send a fifth message S5 to the stationary control 84 via the third data connection 53, which is a test message. The stationary control 84 sends a sixth message S6 to the mobile conveyor control 24, confirming receipt of the test message/fifth message S5. Only in case that the third data connection 53 is established, the fifth and sixth message S5, S6 can be transmitted between the mobile conveyor control 24 and the stationary conveyor control 84.

Here the determination of the quality, in particular the pure existence, of the established third data 53 connection serves as validation step for the handover position. In case that the couplers are not perfectly aligned to each other, the quality of the data transmission is reduced. In case the data quality of the data transmission is below a certain threshold value, it is assumed that the mobile conveyor 1 is not in a proper handover position for reliable transfer of the object 9 between the two conveyors. As a consequence the position of the mobile conveyor 1 is adapted to improve the alignment between the couplers 29, 89 and the conveyor tracks 21, 81.

In particular the stationary coupler 89 and the mobile coupler 29 are adjusted on the mobile conveyor 1 and on the stationary conveyor 8 in a manner to establish the third data connection 53 only in case that the mobile conveyor 1 is in the handover position with the stationary conveyor 8.

The messages S3 and S4 can be send before, at the same time or after the messages S5 and S6.

If a request for transferring an object 9 (message S4) and if a confirmation that test message (sixth message S6) has received at the mobile conveyor control 24, the mobile conveyor control 24 sends in a seventh message S7 a request to the stationary control 84, whether the stationary conveyor 8 is ready to receive an object 9. The stationary conveyor 8 may not be ready to receive an object 9 in case that the stationary presence sensor 85 detects that an object 9 is present on the stationary conveyor track 81. The stationary conveyor 8 may be ready to receive an object 9 in case that the stationary presence sensor 85 does not detect that an object 9 is present on the stationary conveyor track 81.

In case the stationary conveyor 8 is ready to receive an object 9 the stationary control 84 sends an eighth message S8, confirming said ready status. After receipt of this message at the mobile conveyor control 24, the mobile conveyor 1 starts operation. Thereby the mobile conveyor control 24 instructs the mobile conveyor drive M2 to operate. At the same time the mobile conveyor control 24 sends a ninth message S9 to the stationary control 84, that an object 9 will be transmitted. As a consequence, stationary control 84 instructs the stationary conveyor drive M8 to operate.

As the stationary conveyor 8 receives the object 9 (e.g. detected by means of the stationary presence sensor 85) the stationary control 84 sends a tenth message S10 to the mobile conveyor control 24, confirming that the object 9 has been received a the stationary conveyor 8.

As the mobile conveyor control 24 receives the tenth message S10, mobile conveyor control 24 sends an eleventh message S11 to the travel module control 34, confirming that the object 9 has been transmitted.

As the travel module control 34 receives the eleventh message S11 travel module control 34 sends a twelfth message S12 to the arrangement control 104, confirming that the object 9 has been delivered.

The following table summarizes the above communication.

| | Between | | |
|---|---|---|---|
| | controls | | |
| | (sending | | |
| | device -> | | |
| Message | receiving | used data | |
| ID | device) | connection | Content of message |
| S1 | 104->34 | 51 | destination instructions, provide target position |
| S2 | 34->104 | 51 | confirmation that target position is reached |
| S3 | 104->34 | 51 | request for delivering object |
| S4 | 34->24 | 52 | request for transferring object |
| S5 | 24->84 | 53 | test message to test third data connection |
| S6 | 84->24 | 53 | confirmation that test message is received |
| S7 | 24->84 | 53 | request “ready for receiving object” |
| S8 | 84->24 | 53 | confirmation “ready for receiving object” |
| S9 | 24->84 | 53 | start conveying operation |
| S10 | 84->24 | 53 | Confirmation object received |
| S11 | 24->34 | 52 | confirmation object transferred |
| S12 | 34->104 | 51 | confirmation object delivered |

The term “message” is to be understood in a broad manner. It comprises a push message which is initiated by a sending device. The term “message” also comprises an information which is lying in a database of a sending device and which is provided by the sending device only upon request of the receiving device (pull information). Many other implementations are possible.

LIST OF REFERENCE NUMERALS

| | |
|---|---|
| 1 | mobile conveyor |
| 2 | conveyor module |
| 3 | travel module |
| 4 | fastener |
| 8 | stationary conveyor |
| 9 | object to be conveyed |
| P | conveying path |
| 14 | mobile control |
| M2 | mobile conveyor drive |
| 21 | mobile conveyor track |
| 22 | mobile support frame |
| 24 | mobile conveyor control |
| 25 | mobile presence sensor |
| 26 | conveyor module energy interface |
| 27 | conveyor module control interface |
| 29 | mobile control coupler |
| M3 | travel drive |
| 32 | travel module housing |
| 33 | energy storage |
| 34 | travel module control |
| 36 | travel module energy interface |
| 37 | travel module control interface |
| 38 | wireless control interface |
| 51 | first data connection |
| 52 | second data connection |
| 53 | third data connection |
| M8 | stationary conveyor drive |
| 81 | stationary conveyor track |
| 82 | stationary support frame |
| 83 | power line |
| 84 | stationary control/stationary conveyor control |
| 85 | stationary presence sensor |
| 89 | stationary control coupler |
| 100 | conveying arrangement |
| 104 | arrangement control |
| 111 | data connection |
| S1 . . . S12 | first . . . twelve message |

1. Conveyor arrangement (100), comprising
a mobile conveyor (1) having a mobile conveyor track (21), the mobile conveyor track (21) is adapted to convey an object (9) between different positions along said mobile conveyor track (21) and/or to transfer said object from and/or to said mobile conveyor (1),
a stationary conveyor (8) having a stationary conveyor track (81), the stationary conveyor track (81) is adapted to convey an object (9) between different positions along said stationary conveyor track (81) and/or to transfer said object from and/or to said stationary conveyor (8);
wherein in a regular mode of operation the mobile conveyor is operated in a mobile use and stationary use, and
wherein in a regular mode of operation the stationary conveyor is operated in a stationary use and not in a mobile use,
the mobile conveyor (1) has a travel module (3) and a conveyor module (2) separate thereof,
wherein the travel module (3) is adapted to change its position within an area of operation, in particular in a non-mechanically track-bound manner,
the mobile conveyor (1) has a conveyor module (2) comprising said mobile conveyor track (21);
the conveyor arrangement (100) has
an arrangement control (104) adapted to coordinate overall conveying operations within the conveyor arrangement (100);
a travel module control (34) adapted to control the operation of the travel module (3), in particular to control the operation of a travel drive (M3) of the travel module (3), based on a message (S1, S3) provided by the central arrangement control (104);
a mobile conveyor control (24) separate to the travel module control (34) and adapted to control the operation of the mobile conveyor track (21) based on a message (S4) provided by the travel module control (34).

2. Conveyor arrangement (100) according to claim 1,
characterized in
that the travel module (3) has a travel module housing (32) and the conveyor module (2) has a mobile support frame (22),
wherein the mobile support frame (22) is separate to the travel module housing (32),
wherein the mobile support frame (22) is attached to the travel module housing (32) by a fastener (4),
wherein the travel module control (34) is attached to the travel module housing (32), wherein the mobile conveyor control (24) is attached to the mobile support frame (22).

3. Conveyor arrangement (100) according to claim 1,
characterized in
that the arrangement control (104) is connected to the travel module control (34) by a first data connection (51);
that the travel module control (34) is connected to the mobile conveyor control (24) by a second data connection (52);
in particular:
wherein the first data connection (51) is a wireless data connection and/or a permanent data connection;
wherein the second data connection (52) is a wired data connection and/or a permanent data connection.

4. Conveyor arrangement (100) according to claim 1,
characterized by
a stationary control (84) adapted to control the operation of the stationary conveyor track (81) based on a message (S4) provided by the mobile conveyor control (24).

5. Conveyor arrangement (100) according to claim 4,
characterized in
that the stationary control (84) is connected to the mobile conveyor control (24) by a third data connection (53).

6. Conveyor arrangement (100) according to claim 5,
characterized in
that the third data connection (53) is a temporary data connection.

7. Conveyor arrangement (100) according to claim 5,
characterized in
that the third data connection (53) uses a near-field data communication technology;
in particular wherein the near-field data communication technology requiring a defined orientation between the mobile conveyor (1) and the stationary conveyor (8).

8. Conveyor arrangement (100) according to claim 4,
characterized in
that the stationary control (84) is not connected to the arrangement control (104).

9. Method of operating a conveyor arrangement (100) according to claim 1.

10. Method according to claim 9,
wherein the arrangement control (104) provides a message (S3) only to the travel module control (34), in particular not to the stationary conveyor control (84), to start delivering an object to the stationary conveyor (8).

11. Method according to claim 9,
wherein the mobile conveyor control (24) receives a message (S4) from the travel module control (34) to start operation.

12. Method according to claim 9,
wherein the stationary conveyor control (84) receives a message (S9) indicating to start operation from the mobile conveyor control (24).

13. Method according to claim 9,
wherein the mobile conveyor control (24) receives a message (S10) from the stationary conveyor control (84) indicating that an object is received at the stationary conveyor (8).

14. Method according to claim 9,
wherein the travel module control (34) receives a message (S11) from the mobile conveyor control (24), confirming that the object (9) has been transferred from the mobile conveyor (1) to the stationary conveyor (8).

15. Method according to claim 9,
wherein the arrangement control (104) receives a message (S12) from the travel module control (34) confirming that an object (9) has been delivered from the mobile conveyor (1) to the stationary conveyor (8).
